(19) United States
(12) Patent Application Publication
(10) Pub. No.: US 2009/0192006 A1
(43) Pub. Date: Jul. 30, 2009

(54) TRANSMISSION FOR TRANSMITTING A DRIVE TORQUE FROM ONE DRIVE SHAFT TO TWO OUTPUT SHAFTS

(76) Inventors: Alois Böck, Hutthurm (DE); Detlef Baasch, Friedrichshafen (DE); Robert Peter, Friedrichshafen (DE); Florian Knedler, Passau (DE); Michael Donaubauer, Untergriesbach (DE)

Correspondence Address: DAVIS & BUJOLD, P.L.L.C., 112 PLEASANT STREET, CONCORD, NH, 03301, US

(21) Appl. No.: 12/302,098

(22) PCT Filed: Apr. 25, 2007
(86) PCT No.: PCT/EP07/55082

§ 371 Date: Nov. 24, 2008

(30) Foreign Application Priority Data
May 30, 2006 (DE) 10 2006 025 062.1

(51) Int. Cl. F16H 48/06; F16H 37/08

(52) U.S. Cl. 475/205; 475/225

(57) ABSTRACT

A rear axle transmission unit is proposed for transmitting a drive torque from a drive input shaft to two drive output shafts via a differential unit and a device, which can be actuated and continuously adjusted by at least one motor for influencing the drive torque distribution level to the output shafts, such that the differential unit comprises a differential and a differential cage actively connected to the drive shaft and the device for influencing the drive torque distribution level comprises at least one planetary gearset as a transmission ratio stage which is actively connected to the differential cage and to an associated output shaft and which comprises a brake device. It is provided that the brake device is arranged laterally offset in the direction of a planetary axis next to planetary gears of the transmission ratio stage and at least approximately inside a radial extension area of the planetary gears around a longitudinal axis of the output shafts.

This application is a national stage completion of PCT/EP2007/055 082 filed May 25, 2007, which claims priority from German Application Serial No. 10 2006 025 062.1 filed May 30, 2006.

### FIELD OF THE INVENTION

The invention concerns a transmission unit for transmitting a drive torque from a drive shaft to two drive output shafts.

### BACKGROUND OF THE INVENTION

Such a transmission unit is known from FR 2 864 190. In that document, an asymmetrical transfer box is described, which distributes a drive torque produced by a drive engine, by way of a differential unit, to two wheels connected with a drive output shaft. A differential of the differential unit distributes the drive torque uniformly to the two drive output shafts.

To produce another torque distribution made necessary by driving round a curve, with each of the two drive output shafts is associated a torque-vectoring unit with a planetary gearset, which is arranged between a differential cage of the differential unit and the respective drive output shaft and by way of which the drive torque, acting on the respective drive output shaft, can be influenced. For this purpose, the carrier of the planetary gearset can be braked by way of a brake relative to a transmission housing in order to produce a torque-vectoring torque, where the torque-vectoring torque, supported on the transmission housing, is transferred to the respective wheel by a transmission ratio stage comprising the planetary gears and the sun gears of the planetary gearset.

In this case, the respective drive output shaft and the differential cage are each connected fixed to a sun gear of the planetary gearset and the sun gears each cooperate with a planetary gear arranged on the planetary. In addition, a planetary gear carrier of the planetary gearset is rotationally connected with the planetaries, and a mounting of the planetary gear carrier is located in an area of the planetary gearset remote from a center of the transmission. The brake, which is arranged on the planetary carrier of the planetary gearset, is arranged relative to the longitudinal axis of the drive output shafts radially outside an axis of the planetary gears.

In the transmission unit known from FR 2 864 190, with an arrangement of a brake device as described above, the brake disadvantageously takes up a very large amount of structural space and this entails correspondingly high material and production costs.

The purpose of the present invention is to design a transmission unit of the type described at the start, such that a brake device for actuating a device for influencing the distribution level of the drive torque to the drive output wheels, which ensures reliable functionality and occupies little structural space, can be produced inexpensively.

According to the invention, this objective is achieved with a transmission unit for transmitting a drive torque to two drive output shafts.

### SUMMARY OF THE INVENTION

Thus, a transmission unit is provided, in particular a rear axle transmission unit for transmitting a drive torque from a drive input shaft to two drive output shafts, via a differential unit and a continuously variable device, activated by at least one motor for influencing the distribution level of the drive torque to the drive output shafts, such that the differential unit comprises a differential and a differential cage actively connected to the drive input shaft and the device for influencing the distribution level of the drive torque comprises at least one planetary gearset as the transmission ratio stage, which is actively connected to the differential cage and an associated drive output shaft and which comprises a brake device. The brake device is arranged laterally offset in the direction of a planetary gearset axis alongside planetary gears of the transmission ratio stage and at least approximately within a radial extension area of the planetary gears around a longitudinal axis of the drive output shafts.

In a transmission unit constructed by way of its positioning laterally next to the planetary gears and radially close to the longitudinal axis of the output shafts, the brake device can advantageously be made very small so that structural space is saved and the production costs are also reduced. Thanks to the reduction of space occupied by the brake device the entire transmission unit can be made smaller or space can be provided for other components.

Depending on the application, it can be appropriate for the brake device, relative to a central axis of the transmission running perpendicularly to the longitudinal axis of the drive output shafts, to be located either in an area facing toward the middle of the transmission or in an area facing away from the middle of the transmission next to the planetary gears.

Preferably, the brake device is constructed with a shift element such as a disk-type shift element and with means for the axial adjustment of the shift element. Depending on the structural space requirements applicable to the transmission unit, the shift element can be arranged either on a side of the planetary gearset facing toward or facing away from the middle of the transmission in the direction of the planetary gear axis, between the means for axial adjustment and the planetary gearset. Furthermore, the axial adjustment means can be arranged either on a side of the planetary gearset facing toward or facing away from the middle of the transmission in the direction of the planetary gear axis between the shift element and the planetary gearset.

In an advantageous design of the transmission unit, the brake device shift element is made as a disk brake. In such a case, the effect of being able to make the brake device smaller is that its disks have smaller diameters. Thanks to the positioning of the brake device, when the disk brake is not actuated, only small drag losses occur since the disks rotate approximately with the same speed as the wheels and, at high rotation speeds, the friction speeds are comparatively low.

The disk brake can be actuated by way of an axial adjustment device by at least one motor in such a manner that the drive input shaft of the motor interacts with a tumbler gear of the axial adjustment device where, by virtue of rolling bodies in particular made as balls located in variable-depth grooves of the tumbler gear and in correspondingly arranged grooves of a ball ramp disk of the axial adjustment device fixed to the housing, the tumbler gear cooperates with the ball ramp disk.

If the drive shaft of the motor cooperates with the tumbler gear of the axial adjustment device, via an at least one-step spur gear stage, a very simple mechanism for actuating the shift element can be made.

As regards the axial adjustment device for the disk brake, the positioning of the brake device has the advantageous effect that there is great freedom of choice for the production technology of the actuator system and production costs can be reduced accordingly. If the ball ramp disk is used as the actuator, the pressure axis of the ball ramp disk can be located advantageously in the area of the diameter of the disks.

### BRIEF DESCRIPTION OF THE DRAWINGS

The invention will now be described, by way of example, with reference to the accompanying drawings in which:

FIG. 1 is a schematic partially sectioned representation of a rear axle transmission unit of a motor vehicle with a planetary gearset designed as a transmission ratio stage, which is constructed with a brake device made with a shift element and an axial adjustment device that actuates the shift element, and

FIG. 2 is a schematic partially sectioned representation of the rear axle transmission unit of FIG. 1 with an alternative arrangement of the brake device.

### DETAILED DESCRIPTION OF THE INVENTION

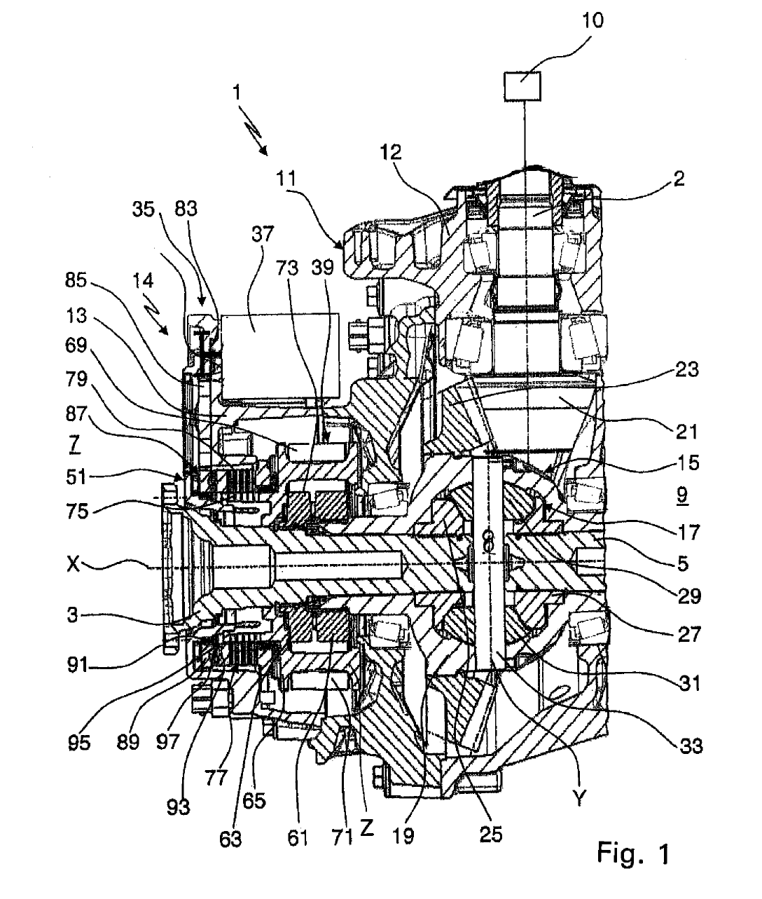

FIG. 1 shows part of a rear axle transmission unit 1, which distributes a drive torque produced by a drive machine or internal combustion engine 10 (shown only schematically) and transmitted by a drive input shaft 2 to a first drive output shaft 3 and a second drive output shaft 5 co-axial with the latter and arranged symmetrically with respect to the drive shaft 2.

The rear axle transmission unit 1 is designed for fitting in a motor vehicle and, in the version illustrated, is a rear axle transmission unit, although it would also be conceivable to use a transmission of substantially analogous structure as a front axle transmission unit. It is also conceivable to use the present transmission unit both as a front axle and as a rear axle transmission unit, for example in an all-wheel-drive motor vehicle.

The drive output shafts 3 and 5, which are mounted to rotate about a common longitudinal axis X, are at their free ends each connected to a vehicle wheel (not shown), such that when installed as a rear axle transmission unit 1 one vehicle wheel is located relative to the drive output shaft 3 on a left side 7 of the transmission as viewed in the forward direction of the vehicle, and one vehicle wheel is located relative to the output shaft 5 on a right side 9 of the transmission.

The rear axle transmission unit 1 comprises a transmission housing 11, which consists of a front transmission housing portion 12 that essentially surrounds the drive input shaft 2, a lateral transmission housing portion 13 associated with a left side 7 of the transmission, out of which the first output shaft 3 projects to the side and a lateral transmission housing portion (not illustrated) associated with the right side 9 of the transmission, out of which the second output shaft 5 projects to the side.

The rear axle transmission 1 distributes the drive torque transmitted from the drive input shaft 2 to the two drive output shafts 3 and 5 and can during this also produce an unequal torque distribution to the two output shafts 3 and 5 and thereby actively improve the driving characteristics. In this case, the drive torque from the drive shaft 2 passes into a differential unit 15 comprising a differential 17 and a differential cage 19, which is connected to a device 14 for influencing the drive torque on the output shafts 3 and 5.

To form the active connection between the drive shaft 2 and the differential cage 19, a drive pinion 21, which is connected to the drive shaft 2 engages with a spur bevel gear 23, which is connected to the differential cage 19, the differential cage 19 being mounted to rotate about the longitudinal axis X and being supported in the transmission housing 11.

In a known structural configuration, the differential 17 comprises two bevel gears 25 and 27, respectively, connected on the drive output side with the output shafts 3 and 5, and two bevel gears 29 and 31 which mesh on the drive input side with the two bevel gears 25 and 27. The two input-side bevel gears 29 and 31 are mounted to rotate on a shaft-bolt 33 which is fixed in the differential cage 19 in relation to rotation about the longitudinal axis X.

FIG. 1 shows two example embodiments of the drive input-side bevel gears 29 and 31 and the output-side bevel gears 27 and 25 that cooperate with them, respectively engaged with one another, although those with knowledge of the field can choose an alternative configuration in accordance with the application in each case.

When a drive torque from the internal combustion engine 10 is transmitted via the drive shaft 2, this is transferred by the drive pinion 21 to the spur bevel gear 23 and the differential cage 19 fixed to the latter. By way of the shaft-bolt 33 of the differential 17 connected to the differential cage 19, the drive torque is transmitted to the input-side bevel gears 29 and 31 of the differential 17 which, in turn, transfer the drive torque to the output-side bevel gears 25 and 27 and hence drive the output shafts 3 and 5.

If there is no speed difference between the two output shafts 3 and 5, the input-side bevel gears 29 and 31 with the shaft-bolt 33 rotate exclusively about the longitudinal axis X. But if one output shaft in the assembled condition rotates more rapidly than the other, because the vehicle wheels are rotating at different speeds as the vehicle is driving round a curve, then the input-side bevel gears 29 and 31 rotate around the shaft-bolt 33 to compensate the rotation speed difference and the shaft-bolt 33, in turn, passes on the drive torque to the two output shafts 3, 5 by way of its rotation about the longitudinal axis X.

Besides compensating for a rotational speed difference between the two output shafts 3 and 5, the rear axle transmission unit 1 can also distribute torque differently to the two output shafts 3 and 5. For that purpose, the device 14 for influencing the drive torque to the output shafts 3 and 5 is provided with two identically made torque-vectoring units arranged symmetrically with respect to a central axis Y of the transmission. Of the two torque-vectoring units, FIG. 1 shows only a torque-vectoring unit 35 associated with the left side 7 of the transmission, which will be described below.

The torque-vectoring units are arranged in the transmission housing 11 and are, in the present case, each continuously adjusted and actuated by an associated, switchable electric motor 37.

As can be seen in the case of the torque-vectoring unit 35 illustrated, this comprises a planetary gearset designed as a transmission ratio stage 39, and a brake device 51 than can be actuated by the electric motor 37. The transmission ratio stage 39 are formed with two sun gears 61 and 63 of which a first sun gear 61 is connectedly fixed to the differential cage 19 and the second sun gear 63 to the drive output shaft 3. The sun gears 61 and 63 cooperate in this case with three planetary gears mounted to rotate on a planetary gear carrier 65, of which two planetary gears 69 and 71 can be seen and which have through-going teeth 73.

The brake device 51 is made with a shift element in the form of a disk brake 77 and a device 87 that cooperates with the shift element for axial adjustment. The disk brake 77, which in relation to its transfer capability, is continuously adjustable and comprises inner disks 75 arranged on the planetary gear carrier 65 which cooperate with outer disks 79 fixed in the transmission housing 11 by way of their axial adjustability in such a manner that they can be brought into or out of frictional contact.

The electric motor 37 actuates the device 87 for axial adjustment, formed with a tumbler gear 89 and a ball ramp disk 91, in this case, via an intermediate gear 85 mounted in a fixed manner on the transmission housing and driven by its drive shaft 83, which engages on one side with the drive shaft 83 of the electric motor 37 and, on the other side, with the tumbler gear 89 of the axial adjustment device 87.

The intermediate gear 85 serves to produce a transmission ratio between the electric motor 37 and the tumbler gear 89, which is determined by the number of teeth of the electric motor 37 and the number of teeth of the tumbler gear 89, and to bridge the distance of the electric motor 37 from the longitudinal axis X, this distance being bridged in particular by the diameter of the intermediate gear 85.

It is at the discretion of those with knowledge of the field to bridge this distance between the electric motor 37 and the longitudinal axis X, as an alternative to the one-stage spur gear step formed as an intermediate gear as in the example embodiment shown, by way of a two-stage or multi-stage spur gear step, in particular depending on the existing structural space conditions.

The ball ramp disk 91, which is mounted in a rotationally fixed manner, but axially movable in the transmission housing 11, has at least three grooves 93 of varying depth distributed over its radius. In grooves 95 of the tumbler gear 89 that correspond to the grooves 93 of the ball ramp disk 91 and whose depth also varies, there are at least three spherical rolling bodies 97 due to which, when the tumbler gear 89 is turned by the electric motor 37, an axial movement of the ball ramp disk 91 results so that after axial movement in the direction of the Y-axis, the outer disks 79 fixed on the housing and the inner disks 75 of the brake device 51 are brought into frictional connection once an air gap of the axial adjustment device 87 has been closed.

When the disk brake 77 is disengaged, the transmission ratio stage 39 rotates about the longitudinal axis X with no torque transmission. If a frictional connection is initiated by the electric motor 37 in the disk brake 77, then from the drive torque a torque-vectoring torque that acts on the respective output shafts 3 and 5 is produced. This happens because the planetary carrier 65 is supported by the brake device 51 in the transmission housing 11. Thus, torque transfer takes place from the drive input shaft 2, via the differential cage 19 and from there, by way of the planetary gear carrier 65 from the first sun gear 61 to the second sun gear 63, respectively, connected to the drive output shaft 3 or 5, such that a different torque distribution to the left output shaft 3 and the right output shaft 5 can be achieved.

In the rear axle transmission unit 1 shown in FIG. 1, the brake device 51 is arranged in an area of the transmission ratio stage 39 facing away from a center of a transmission 8, such that the distance of the brake device 51 from the longitudinal axis X is approximately the same as a planetary gear axis Z and the structural space required is thus advantageously small.

In the present case, the disk brake 77 is arranged in the direction of a planetary gear axis Z, between the transmission ratio stage 39 and the axial adjustment device 87, that can be actuated by the electric motor 37 so that the tumbler gear 89 of the axial adjustment device 87 can be actuated in a simple manner.

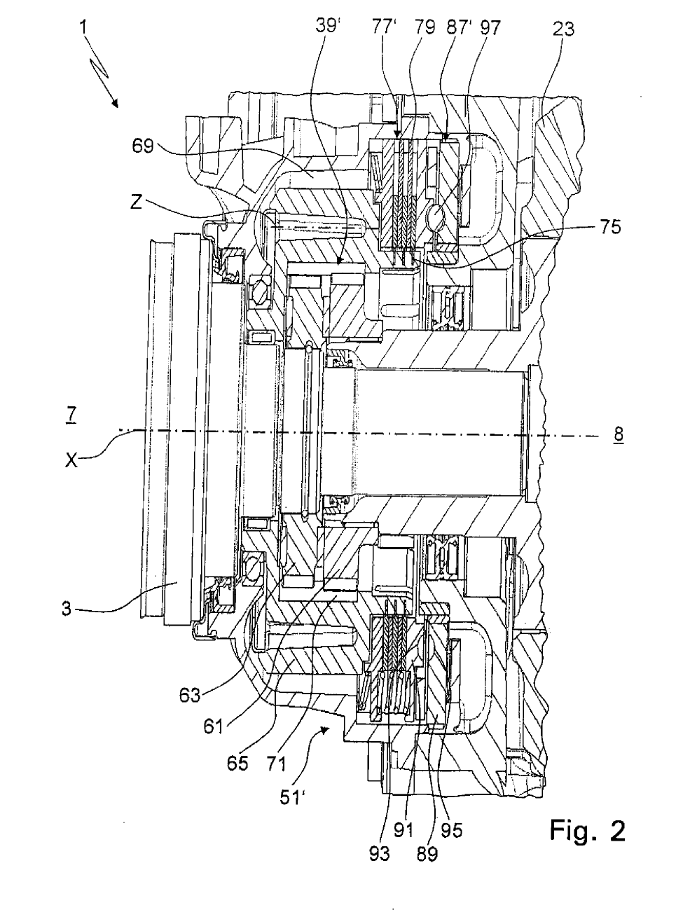

FIG. 2 shows the rear axle transmission unit 1 with an alternative arrangement of a brake device 51′ in relation to a transmission ratio stage 39′, such that the brake device 51′ is arranged in an area of the transmission ratio stage 39′ facing toward the center 8 of the transmission. In this case, as in the example embodiment shown in FIG. 1, a disk brake 77′ is arranged in the direction of the planetary gear axis Z, between an axial adjustment device 87′ and the transmission ratio stage 39′.

It is at the discretion of those with knowledge of the field to arrange the axial adjustment device 87 in an area of the transmission ratio stage 39, 39′ either facing toward or facing away from the center of the transmission 8 between the disk brake 77, 77′ and the transmission ratio stage 39, 39′, in order to suit the specific structural space circumstances.

### REFERENCE NUMERALS

| | |
|---|---|
| 1 | rear axle transmission unit |
| 2 | drive input shaft |
| 3 | first drive output shaft |
| 5 | second drive output shaft |
| 7 | left side of the transmission |
| 8 | center of the transmission |
| 9 | right side of the transmission |
| 10 | internal combustion engine |
| 11 | transmission housing |
| 12 | front transmission housing portion |
| 13 | lateral transmission housing |
| | portion |
| 14 | device for influencing the |
| | distribution level of the drive |
| | torque to the drive output |
| | shafts |
| 15 | differential unit |
| 17 | differential unit |
| 19 | differential cage |
| 21 | drive pinion |
| 23 | spur bevel gear |
| 25 | left output-side bevel gear |
| 27 | right output-side bevel gear |
| 29 | upper input-side bevel gear |
| 31 | lower input-side bevel gear |
| 33 | shaft-bolt |
| 35 | left torque-vectoring unit |
| 37 | electric motor |
| 39 | transmission ratio stage |
| 39′ | transmission ratio stage |
| 51 | brake device |
| 51′ | brake device |
| 61 | first sun gear |
| 63 | second sun gear |
| 65 | planetary gear carrier |
| 69 | planetary gear |
| 71 | planetary gear |
| 73 | planetary gear teeth |
| 75 | inner disks |
| 77 | disk brake of the left torque-vectoring |
| | unit |
| 77′ | disk brake of the left torque-vectoring |
| | unit |
| 79 | outer disks |
| 83 | drive shaft of electric motor |
| 85 | intermediate gear |
| 87 | axial adjustment device |
| 87′ | axial adjustment device |
| 89 | tumbler gear |
| 91 | ball ramp disk |
| 93 | grooves of the ball ramp disk |
| 95 | grooves of the tumbler gear |
| 97 | spheres |
| X | longitudinal axis |
| Y | central axis of the transmission |
| Z | planetary gear axis |

1-10. (canceled)

11. A transmission unit for transmitting drive torque from a drive input shaft (2) to two drive output shafts (3, 5) via a differential unit (15) and a continuously adjustable device (14) that is actuated by at least one motor (37) for influencing a distribution level of the drive torque to the output shafts (3, 5), the differential unit (15) comprises a differential (17) and a differential cage (19) actively connected to the drive shaft (2), and the continuously adjustable device (14), for influencing the distribution level of the drive torque, comprises at least one planetary gearset which is actively connected to the differential cage (19) and an associated output shaft (3, 5) and which comprises a brake device (51, 51′), the brake device (51, 51′) being arranged in a direction of a planetary axis (Z) laterally offset next to planetary gears (69, 71) of the at least one planetary gearset, the brake device (51, 51′) being arranged inside a radial extension area of the planetary gears (69, 71) around a longitudinal axis (X) of the output shafts (3, 5), and the motor (37) is arranged a distance away from the longitudinal axis (X).

12. The transmission unit according to claim 11, wherein the brake device (51′) is arranged closer to a central axis (Y) of the transmission than the adjacent planetary gears (69, 71), and the central axis (Y) extends perpendicular to the longitudinal axis (X) of the output shafts (3, 5) and between two brake devices of the associated output shafts (3, 5).

13. The transmission unit according to claim 11, wherein the brake device (51′) is arranged farther away from a central axis (Y) of the transmission than the adjacent planetary gears (69, 71), and the central axis (Y) of the transmission extends perpendicular to the longitudinal axis (X) of the output shafts (3, 5).

14. The transmission unit according to claim 11, wherein the brake device (51, 51′) comprises a shift element (77, 77′) and an axial adjustment device (87, 87′) of the shift element, the axial adjustment device (87, 87′) is arranged in the direction of the planetary gear axis (Z), between the planetary gears (69, 71) and the shift element (77, 77′).

15. The transmission unit according to claim 11, wherein the brake device (51, 51′) comprises a shift element (77, 77′) and an axial adjustment device (87, 87′) for axially adjusting the shift element (77, 77′), and the shift element (77, 77′) is arranged in the direction of the planetary axis (Z), between the planetary gears (69, 71) and the axial adjustment device (87, 87′).

16. The transmission unit according to claim 11, wherein the continuously adjustable device (14), for influencing the drive torque distribution level, comprises two planetary gearsets (39, 39′) each with a brake device (51, 51′) arranged at least approximately symmetrically relative to a central transmission axis (Y), which extends perpendicularly to the longitudinal axis (X) of the drive output shafts (3, 5).

17. The transmission unit according to claim 16, wherein the two planetary gearsets (39, 39′) are connected to the continuously adjustable device (14) in relation to a transmission capacity of a respective frictional shift element (77, 77′) of the continuously adjustable device (14) for influencing the distribution level of the drive torque, and the transmission capacity of the respective shift element (77, 77′) is adjustable by the at least one motor (37).

18. The transmission unit according to claim 11, wherein the brake device (51, 51′) has as a disk brake (77, 77′), and the disk brake (77, 77′) is actuated by an axial adjustment device (87, 87′) of the brake device (51, 51′) that is actuated by the at least one motor (37).

19. The transmission unit according to claim 18, wherein a drive shaft (83) of the at least one motor (37) interacts with a tumbler gear (89) of the axial adjustment device (87, 87′) so that the tumbler gear (89), via rolling bodies located in variable-depth grooves (95) of the tumbler gear (89) and in correspondingly arranged grooves (93) of a ball ramp disk (91) of the axial adjustment device (87, 87′) fixed on the housing, co-operates with the ball ramp disk (91).

20. The transmission unit according to claim 19, wherein the drive shaft (83) of the at least one motor (37) co-operates with the tumbler gear (89) via at least one-step spur gear stage (85).

21. A rear axle transmission unit, for transmitting a drive torque from a drive input shaft (2) to two drive output shafts (3, 5), the transmission unit comprising:
a differential unit (15) including a differential (17) and a differential cage (19) actively connected to the drive shaft (2); and
a continuously adjustable device (14) being actuated by at least one motor (37) for adjusting the drive torque to the two output shafts (3, 5), and the continuously adjustable device (14) comprises
at least one transmission ratio stage (39, 39′), communicating with the differential cage (19) and an associated one of the two output shafts (3, 5) and a brake device (51, 51′), being axially arranged adjacent to but laterally offset from planetary gears (69, 71), which rotate about a planetary axis (Z), the brake device (51, 51′) being arranged inside a radial extension area of the planetary gears (69, 71) around a longitudinal axis (X) of the two output shafts (3, 5) and the motor (37) being spaced a distance away from the longitudinal axis (X).
